(19) United States
(12) Patent Application Publication
(10) Pub. No.: US 2005/0250536 A1
(43) Pub. Date: Nov. 10, 2005

(54) Method and system for wireless data communication in data processing system

(76) Inventors: Guoshun Deng, Guangdong (CN); Xiaohua Cheng, Beijing (CN); Feng Xiang, Guangdong (CN)

Correspondence Address: BRINKS HOFER GILSON & LIONE, P.O. BOX 10395, CHICAGO, IL, 60610, US

(21) Appl. No.: 10/502,921

(22) PCT Filed: Jun. 26, 2002
(86) PCT No.: PCT/CN02/00443

§ 371 Date: Feb. 15, 2005

(30) Foreign Application Priority Data
Jan. 26, 2002 (CN) 02114797.3

(51) Int. Cl. H04M 1/00

(52) U.S. Cl. 455/558; 455/422.1

(57) ABSTRACT

A method of wireless data communication in a data processing system comprise the steps of providing a wireless data communication device, in which installed are a wireless transceiver module for receiving and transmitting data information, and a controller and an interface module for controlling the wireless data communication device; establishing an information exchange channel between the device and the data processing system based on a serial or parallel connection or wireless communication interface; wherein the wireless data communication device transmits or receives the data information through the wireless transceiver module via a public wireless network. The device is connected with a variety of data processing equipments, such as, a computer host through a variety of interfaces, and has a wireless transceiver module which can receive or transmit information through a mobile telephone network, uses directly communication services provided by the mobile telephone network company, and thus has the advantages of being online at any time but at low cost. It can also connect to the Internet for transmitting and receiving information so as to realize wireless access to the Internet.

### RELATED APPLICATIONS

The present patent document claims priority to PCT Application Serial No. PCT/CN02/00443, filed on Jun. 6, 2002, designating the United States and published in Chinese, and claims priority to Chinese Patent Application No. 02114797.3, filed on Jan. 26, 2002, which is hereby incorporated by reference.

### TECHNICAL FIELD

The present invention relates to the wireless transmission of data information, more particularly, to the wireless transmission of data from a computer system using a public wireless network to communicate and a device configured for such communication.

### BACKGROUND ART

The rapid development of computer technology and the Internet has brought us into the information age. However, the computers have been connected to the Internet through a wired public telephone switching network or through other wired private network interface. Such a connection is not convenient for people who are traveling and need to send or receive information, but cannot rind a usable network connection. The prevalence of mobile telephones provides instantaneous communication with almost anyone at the spur of the moment, providing both voice and short message or text messaging services upon demand. However, people have various needs requiring an information service. For instance, a securities brokerage house needs to inform its clients promptly about instantaneously changing information in the stock market, and a bank needs to exchange financial information with its respective banking branches securely. Such stock market and financial information needs to be exchanged through a network, and sometimes needs to be stored conveniently for people to study repeatedly.

### SUMMARY OF THE INVENTION

The present invention provides a system for wireless data communication that overcomes the deficiencies of the prior art. The system includes methods for communicating data wirelessly and the devices that are part of the implementation of the system. Specifically, the system enables receipt and transmission of the information through a public wireless network, where the device may have a storage function and contain the subscribers' identification codes.

A system of wireless data communication for a data processing system may include the following steps:
A Communicating through a wireless data communication device having a wireless transceiver module capable of receiving or transmitting data, and including a controller module that controls the wireless data communication device and an interface module. The various modules may be separate or may be integrated into as few as one or two modules.
B. Establishing an information exchange channel between the wireless data communication device and a data processing system based on a serial, parallel, or wireless communication interface.
C. Wherein the wireless data communication device uses the wireless transceiver module to transmit or receive the data information through a public wireless network such as a telephone network

Other embodiments of the method may include any of the steps of:
D. Storing data in a storage media module that may be installed in the wireless data communication device thus enabling the wireless data communication device to provide external storage for the data processing system.
E. Providing identification codes stored in an identity code module on the wireless data communication device.
F. Using a driver in the data processing system to control and drive the wireless data communication device.
G. Using a serial, parallel, or wireless communication interface that may include a Universal Serial Bus (USB), IEEE1394, Personal Computer Memory Card (PCMCIA), CP, or Bluetooth standard.
H. Formatting the wireless communication device for use in a public wireless network using a Global System for Communication (GSM). General Packet For Radio Service (GPRS), Code-Division Multiple Access (CDMA), wide-band CDMA (WCDMA), CDMA2000 or Cellular Digit Packet Data (CDPD) formatted network.
I. Providing power to an operational power supply for the wireless data communication device via a serial or parallel interface,
J. Indicating the operational status of the wireless data communication device with an operational state indicating module, including an element showing the status on the operational state indicating module that may be an light emitting diode (LED), liquid crystal display (LCD), vibrator, or even an audible alarm.
K. Providing a write protection function to prevent data from being written into the storage media module.
L. Providing for a secure transmission of data with a Subscriber Identity Module (SAM) card.

The wireless data communication device for a data processing system may include a serial, parallel, or wireless communication interface module that connects the data processing system and the wireless data communication device. It also may include a controller module and a wireless transceiver module. The controller module is connected to the interface module and the wireless transceiver module and supports the flow of data information while coordinating the operation of the various modules. The wireless data communication device may include a storage media module that may use a flash memory or other type of known memory. It also may include an identification code module for storing identification codes.

The wireless data communication device may connect to various data processing devices, such as a computer host, through various interfaces. The wireless data communication device has a wireless receive and transmit module that receives and transmits data through a wireless telephone network or other communication service provided by mobile telephone companies such as the China Mobile company, the China Unicom company in China. Communications may include short messages, voice, data communication, and the like. Advantages of such a service include a wide regional coverage, the ability to be online at any given moment and low cost. The device may also be connected to the Internet to transmit or receive information thus achieving the functions of wireless access.

### BRIEF DESCRIPTION OF THE DRAWINGS

FIG. 1 is a block diagram of the wireless data communication device.

FIG. 2 is a circuit diagram of the power supply module.

FIG. 3 is a circuit diagram of the operational state indicating module.

FIG. 4 is a circuit diagram of the identification code module.

FIG. 5 is a circuit diagram of the interface for the SIM card.

FIG. 6 is a circuit diagram of the USB HUB module.

FIG. 7 is a circuit diagram of the controller module in the wireless data communication device.

FIG. 8 is a circuit diagram of a Siemens TC35 module.

FIG. 9 is a circuit diagram of a Wavecom WIS02C module.

FIG. 10 is a circuit diagram an UbiNetics GM400/GM401 module.

FIG. 11 is a circuit diagram of the storage media control module.

FIG. 12 is a circuit diagram of the storage media module.

FIG. 13 is a block diagram of the operating hierarchy of the wireless data communication device attached to a data processing system.

FIG. 14 is a flow diagram of the first firmware program.

FIG. 15 is a flow diagram of the second firmware program.

FIG. 16 is a flow diagram of the second driver.

FIG. 17 is a network diagram.

FIG. 18-1 is a schematic diagram of the insertion structure for the SIM card.

FIG. 18-2 is a diagram of the SIM card.

FIG. 18-3 is a diagram of a wireless data communication device with a slot for the SIM card.

FIG. 19 is a flow diagram for establishing a virtual serial port.

### DETAIL DESCRIPTION OF PREFERRED EMBODIMENTS

The preferred embodiments of the wireless data communication system will be described in detail in conjunction with the accompanying drawings. The system includes methods for communicating data wirelessly and devices that are part of the implementation of the methods.

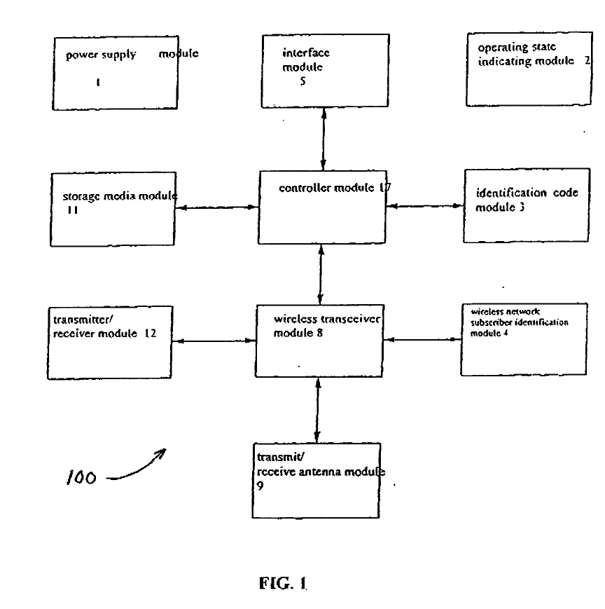

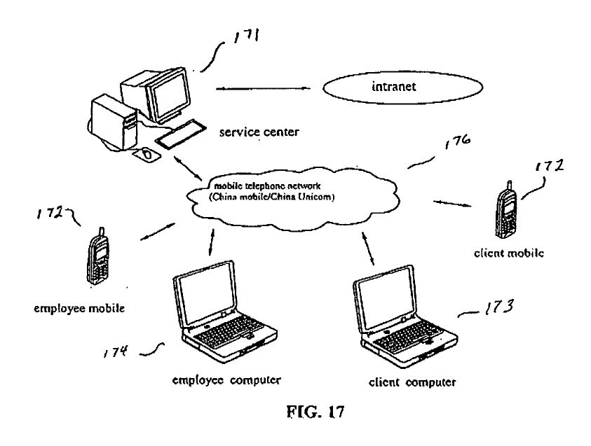

An embodiment of a method of wireless data communication for a data processing system, shown in FIG. 1, may include the following steps:
A. Communicating through a wireless data communication device 100 that includes a wireless transceiver module 8 capable of receiving and/or transmitting data information, an interface module 5, and a controller module 17 for controlling the wireless data communication device 100, where the various modules may be separate or may be integrated into one or more modules.
B. Establishing an information exchange channel between the wireless data communication device 100 and a data processing system 171, as shown in FIG. 17, based on a serial, parallel, or wireless communication interface 5.
C. Using the wireless transceiver nodule 8 on the wireless data communication device 100 to transmit or receive the data or information via a public wireless network 176.
D. Installing a storage media module 11 in the wireless data communication device 100 to provide the wireless data communication device 100 with an external storage function of the data processing system 171.
E. Providing the wireless data communication device 100 with identification codes that are stored in an identification code module 3.
F. Providing a driver in the application software of the wireless data communication device 100 to the operating system of the data processing system 171 to control and drive the wireless data communication device 100.

Other embodiments of the wireless data communication device 100 may include one or more other steps such as: device 100 supports the flow of data information and coordinates the operation of the various modules. In other embodiments, the controller module 17 may be connected to a storage media module 11 and/or an identification code module 3. The embodiment that includes a storage media module 11, may use a flash memory. The wireless data communication device 100 also may include a write protection switch (not shown) for preventing data from being written into the storage media module 11.

Another example of the wireless data communication device 100 includes an identification code module 3 that stores an identification code identifying the wireless data communication device 100. The code may be a serial number or a character string written into the wireless data communication device 100 as firmware thus making the module 3 a type of electrical identification card. Further, this identification code may be modifiable, and it may also include a group of serial numbers or character strings.

The serial, parallel, or wireless communication interface module 5 may include the USB, IEEE 1394, PCMCIA, CF, Bluetooth, or other communication interface standard. An operational power supply for the wireless data communication device 100 may be connected via the serial or parallel interface.

An embodiment of the wireless data communication device 100 may indicate the operational status by providing an operating state indicating module 2. This module 2 may include an LED, LCD, vibrator, or audible alarm for displaying the operational state.

The data processing system 171 to which the wireless data communication device attaches, refers generally to various electronic devices capable of processing data, including but not limited to personal computers 173 and 174, minicomputers, data processing workstations 171, and other private data processing systems that might require external storage devices as shown in FIG. 17.

As illustrated in FIG. 1, the hardware structure of the wireless data communication device 100 may be separated into a plurality of modules with some of the functions of the separate modules combined into one or more modules The functions of the individual modules are described as follows.

The power supply module 1 provides the power to the wireless data communication device 100 and converts the 5 VDC power provided by the host USB bus into 3.3VDC to meet the power requirements of the operation of the storage media module 11 and wireless transceiver module 8. For simplification, the connection lines between the power supply 1 and other modules are omitted in FIG. 1.

An embodiment may combine both the mobile communication and mobile storage capabilities thus providing a wireless data communication device that communicates with the public wireless network and allows the user to store information obtained from the public wireless network in the wireless data communication device. In a preferred embodiment, the wireless data communication device is a small package and is lightweight and may achieve a crossover data transfer among devices such as wireless telephones and computers.

An embodiment of the wireless data communication device may include a USB interface mapped onto the data format of an RS232 serial interface, such that a conventional application program operational through the serial port may be applied without any modification. Such formatting provides advantages when compared with conventional storage communication products in terms of security, facility, universality, and portability. For example, one data processing system may attach several communication devices to improve the availability of any one device, thus increasing the throughput of data by transmitting and receiving information in batches without blocking or waiting for an available transmission window. Such an application is suitable for a group of users.

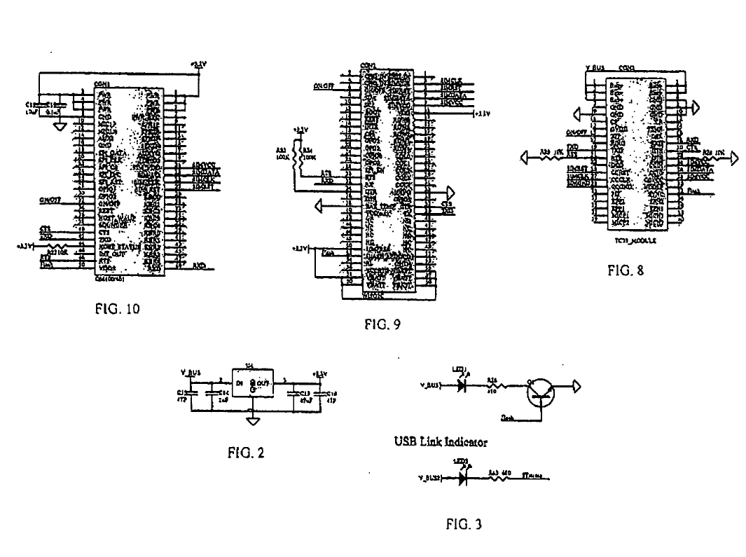

FIG. 2 shows the power supply module 1. The V_BUS is a 5VDC power supply provided by the USB bus originating in the host data processing system 171, which is then converted into 3.3VDC by the chip U4 and filtered by the parallel-connected capacitors C13, C14, C15, C16. It is then supplied to the remaining modules in the communication device 100 requiring this power.

The operational state indicating module 2 provides an indication of the operational status of both the wireless transceiver module 8 when and while it is communicating with the network 176, and the interface connection showing whether it is operating normally. For simplification, the connection lines between the operating state indicating module 2 and other modules are omitted in FIG. 1.

FIG. 3 is a circuit diagram showing the circuit for the operational state indicating module 2. A flash signal from the wireless transceiver module 8 is the input signal to the base electrode of the transistor Q1. The output of transistor Q1 controls the light-emitting diode LED 1 indicating the wireless transmitting/receiving operational state. The V-BUS bus provides power for this circuit. As shown in FIG. 3, the ST status signal from the controller module 17 and the 5VDC from V_BUS2 (coming from the power supply module 1) control the light-emitting diode LED 3 and may indicate the type of connection made to the interface 5 (e.g., the USB, IEEE 1394, etc.). The operating state indicating module 2 may include other indicating elements such as an LCD, vibrator or audible alarm.

The identification code module 3, containing an identification code such as a serial number or character string, may be used as the electronic identification card for the device, and may also provide an encryption key for an encryption/decryption algorithm, The identification code module 3 may be connected to the controller module 17 in the mode of a single bus. As shown in FIG. 4, this module 3 may use a DS2401 chip U6, obtaining 5VDC power from the V_BUS1 bus. The identification code may be firmly fixed in the device or it may be modified. The code may include a group of serial numbers or character strings as well.

The function of the wireless network subscriber identification module 4 is to provide identification to the network 176 when the wireless transceiver module 8 is communicating with the wireless network 176 and provides subscriber information to the network 176. The identification module 4 may be, but is not limited to, a card such as the SIM card that was mentioned above, that stores information about the subscriber. The module 4 is connected to the wireless transceiver module 8 through the identification card interface 5 and the controller module 17 oscillator. The first firmware and the second firmware may be provided separately but may also be integrated in the same controller.

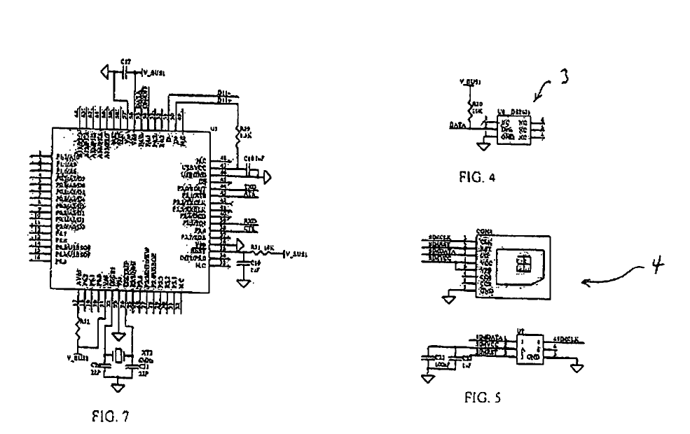

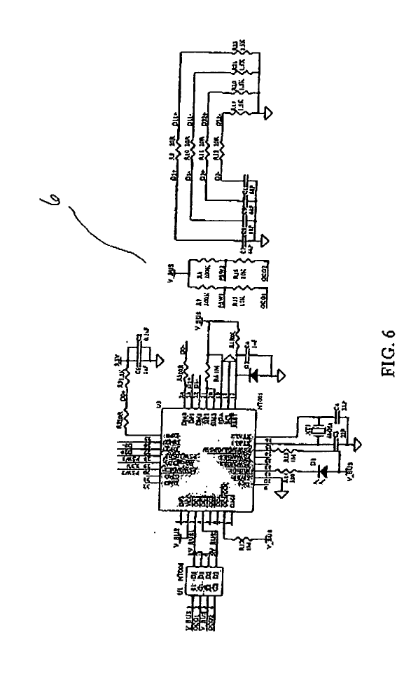

If the controller for the wireless data communication control module and the controller for the storage module 11 in the controller module 17 are separated into two individual control modules (not shown, but are still represented by the control module 17), the interface module 5 may be connected to a USB HUB module 6 shown in FIG. 6, The USB HUB module 6 may provide two downward USB ports to the interface module 5. One downward USB port connects to the controller for the wireless data communication and the other downward USB port connects to controller for the storage module 11 (and are both represented here by the controller module 17 in FIG. 1). As shown in FIG. 6, the USB HUB module 6 uses a NT005 chip 62 to achieve the USB HUB function. The NT006 chip 61 provides current protection for chip NT005. The external clock frequency for this chip is 6 MHz.

The wireless transceiver module 8 communicates information from the controller module 17 and the wireless network subscriber identification module 4 to the transmit/receive antenna module 9. It receives or transmits short message formats (SMS), DATA, FAX, and voice information. In a preferred embodiment, the wireless transceiver module 8 is connected to the wireless network subscriber identification module 4 at a universal SIM card interface, to the controller module 17 through a standard RS232 interface, and to a transceiver antenna 9 through a high-frequency feed line of 50 ohm. If the wireless transceiver module 8 uses a Siemens TC35 chip 80, as shown in FIG. 8, then the wireless data communication device 100 may be operated in a GSM network. If the wireless transceiver module 8 uses a WavecomWIS02C chip 90 as shown in FIG. 9, then the wireless data communication device 100 may operate in a GSM network or a GPRS network. The wireless transceiver module 8 may also use an UbineticsGM400/GM401 chip 99 shown in FIG. 10, then the wireless data communication device 100 will operate in a GSM network or a GPRS network. The wireless transceiver module 8 may use other modules (not shown) such that the wireless data communication device 100 is capable of operating in a CDMA or other network.

The transmit/receive, or transceiver antenna module 9 matches the output impedance of the wireless transceiver module 8 to a high frequency feeder wire. A universal dual frequency mobile phone antenna of 50 ohm is used as the transceiver antenna 9. The transceiver antenna 9 may be separately attached to the wireless data communication device 100 or may be alternatively integrated into the wireless transceiver module 8.

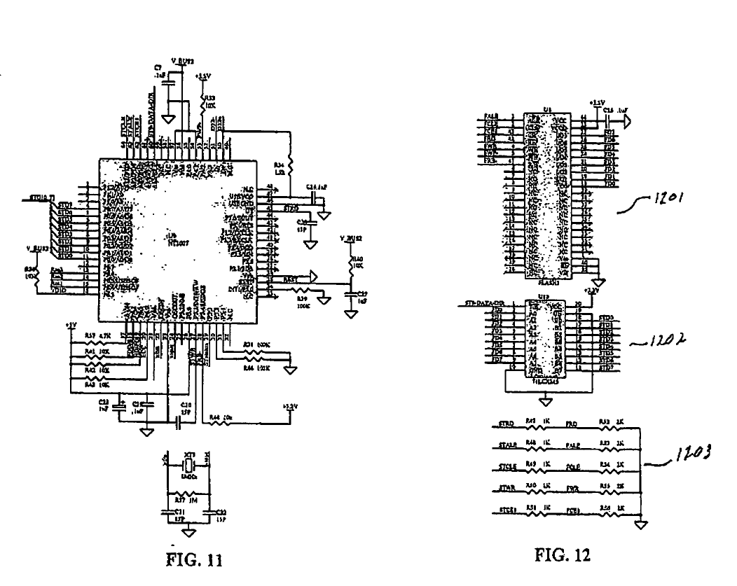

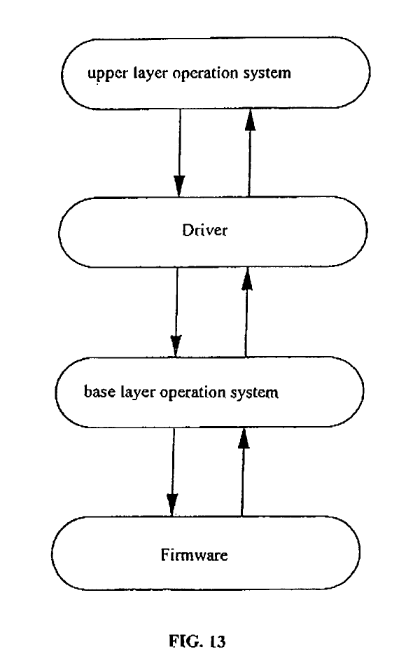

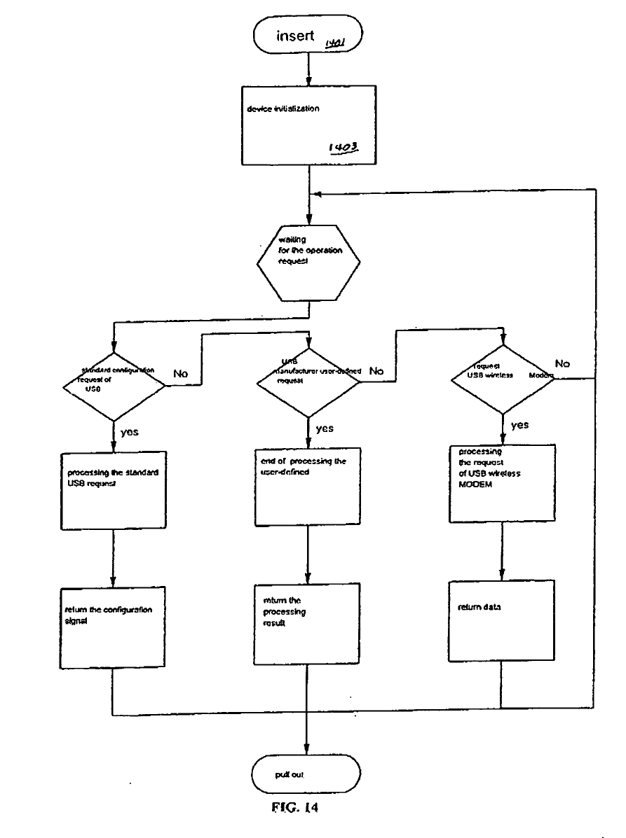

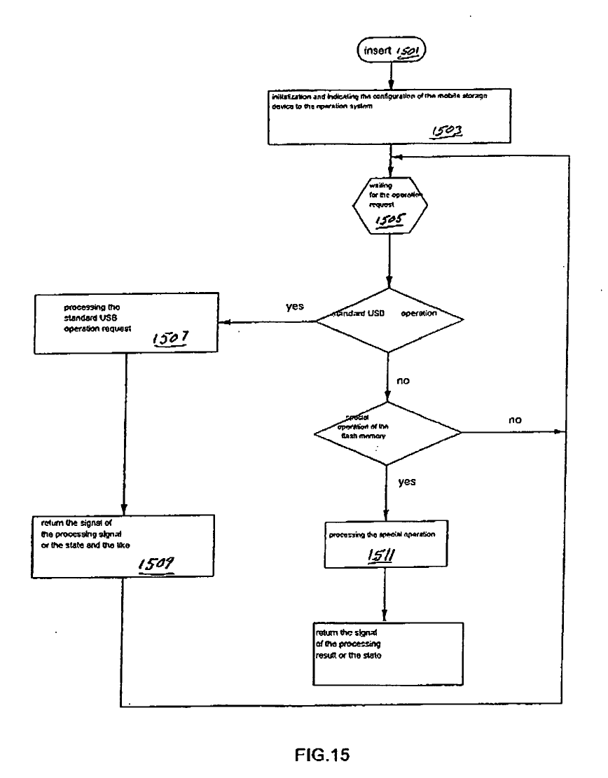

The storage media module 11 stores data files and other information. This module 11 includes the level conversion circuit for data and control signals. The storage media may be a semiconductor storage media, which includes, but is not limited to, flash memory MRAM, DRAM, SDRAM, EEPROM, SRAM, and EPROM. In an embodiment a write protection switch may be included for preventing the transferred data from being written into a storage media module. As shown in FIG. 12, the preferred embodiments of the module use a FLASH 1 chip U8, 1201 and a 74LCX245 chip U10 1202, where the U10 chip 1202 is used to achieve a level conversion of the data signals FD0-FD7 and converts the 5VDC signal level into 3.3VDC signal level. The resistance network 1203 made up of resistors R47, R48, R49, R50, R51, R52, R53, R54, R55, R56 is used to provide the level conversion of the control signal, and converts the 5VDC signal level into 3.3VDC signal level.

The transmitter/receiver module 12 receives voice signals, converts the voice signals into electrical signals for transmission, or converts the electrical signal into the voice signals upon reception and sends the voice signals to a speaker. The connection between the transmitter/receiver module 12 and the wireless transceiver module 8 may send the analog signals bi-directionally. The transmitter/receiver module 12 may use various standard modules that are available in the marketplace.

The firmware may be a combination of software and hardware, where the software is programmed or affirmed into the hardware of the microprocessor. As stated earlier the firmware may be in the controller module 17. When the microprocessor is powered up, the firmware performs a series of operations. The relational position of the firmware 1301 in the application software to the base layer operating system 1302, to the upper layer operating system 1304 and the driver 1303 are shown in FIG. 13. The driver 1303 runs in the operating system 1304 of the host computer system.

The functions that the First firmware may perform include:
A. Power-on and initialization, where the serial port of the microprocessor is set to transmit/receive in an interrupt mode, where the serial baud rate may be 9600 bit/s on the RS-232 port;
B. Setting up the USB system so that the message transfer interface is defined as an interrupt transmission and the data interface is defined as a batch transmission and a manufacturer user-defined class that transfers a subscriber identification code;
C. The control of the wireless transceiver module 8; and
D. The performance of the bidirectional transmission of data between the wireless transceiver 8 and the USB interface.

The wireless data communication device with the above installed firmware may use a 32K SRAM as a data buffer, increasing the speed of receiving and transmitting significantly.

An operational flow diagram illustrating the operation of the first firmware is shown in FIG. 14. When a user inserts 1401 a wireless data communication device 100 into a corresponding interface in the computer 173, an operating system in the computer 173 will find the driver for the device automatically at the time of power-on, and the microprocessor or controller module 17, will execute the firmware. The firmware may include the following steps:
A. Initializing step 1403 the microprocessor and its peripheral interface chips.
B. Checking the control path of the USB interface chip, the USB interface chip generating an interrupt to the microprocessor at the same time, and the microprocessor coming into contact with the operating system by operating the USB interface chip, where, after a series of standard USB configurations, all of the drivers suitable for the wireless data communication devices of the present invention are loaded.
C. Accessing the identification code module 3 from the microprocessor by requesting the manufacturer user-defined configuration so as to give a unique code to the operating system, where the code may be used for identification, encryption and the like, and the microprocessor controls the operating state of the wireless transceiver module 8 as required by the operating system.
D. Transmitting the data between the base layer operating system and the wireless transceiver module 8 as performed by the controller 17, when there is a request for the data transmission.

A flow diagram for the second firmware program is shown in FIG. 15. As shown, the wireless data communication device 100 and the storage device 11 are inserted 1501 or connected to the data processing system 171. The firmware initializes 1503 the device and indicates the configuration of the mobile storage device 11 to the operating system. The firmware waits for an operating request 1505, processes the standard USB operation 1507 and the special operation of the flash memory 1509, respectively, and then returns the processing result, state, or other information to the host operating system through the USB interface assisting the performance of the standard USB operation 1507 and the special operation of the flash memory 1511 and subsequently waits for another operating request 1505.

An embodiment of the wireless data communication device 100 may provide a driver that has both the communication and the storage function. In, an embodiment of the device, a write protection switch may be included for preventing the transferred data from being written into a storage media module on the wireless data communication device. Generally speaking, the common driver will provide a software interface for connecting to the computer hardware, and is loaded as part of the operating system. Thus, the user application software accesses the hardware in a standard manner without considering how to control the hardware. The driver for the device utilizes the application software operating the device through a universal programming interface. For instance, the wireless data transmit/receive driver provides a function for establishing a network connection, transmitting/receiving short messages, and cooperates with the host operating system to process the activities for the installation, and removal of the hardware.

In a preferred embodiment the driver uses a USB standard for universality and reliable operation of the wireless data communication device 100. A function of the driver that is different from a driver for a computer peripheral device is to provide a data format of the USB interface mapped onto the data format for the RS232 serial interface. Thus, the present invention becomes a serial device in terms of the operating system and the application program. Thus, a conventional application program based on a serial port may be applied to the wireless data communication device 100 without modification. This requires that the driver for the present invention establish a virtual RS232 serial interface. Moreover, the driver may be able to process situations where multi-port installations are required, or where there is a sudden removal of a peripheral device from the host computer 171 or device.

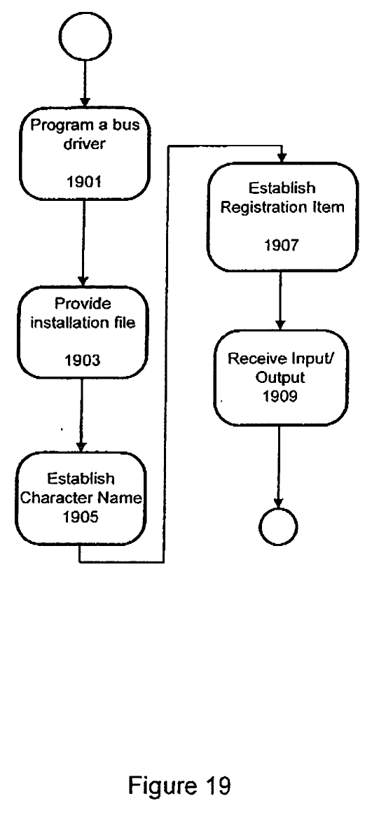

As shown in FIG. 19, the steps for establishing the virtual serial port include:
A. Bus Driver is programmed 1901 for providing a functional drive and enumerating a Physical Device Object (PDO) for the serial port This establishes the virtual serial port by enumerating it in the driver, and then the new device or object is established as representing the virtual port after the proper notice is received. Upon establishment of the virtual port, the bus driver informs the Input/Output Manager by calling IO Invalidate Device Relations, and returning a Unique Hardware ID after receiving the IRP_QUERY_ID message. The driver may request that the user choose a new position for setting up a file during installation of the device. Meanwhile, the driver will indicate the device as an original device when it receives IRP_MN_QUERY_CAPABILITIES.
The installation file is provided 1903 for installing the new device and informs the input/output manager that there is no function driver in the device stack. Since the device is an original device, the new physical device or object processes the input/output request package directly.
For the existing application program to access the device through the serial port, it will: (1) establish 1905 a character name for the connection by pointing to the virtual port device when the IRP_MN_START_DEVICE message is received; and (2) establish 1907 the registration item of class REG_SZ in the serial mapping position for the registration form, of which the name is the device name for the virtual port device and the number is the port number of the virtual port device assigned by the class installation server.
The driver may start receiving 1909 the input/output request package from any serial application program (e.g., Hyperterminal, Dial_Up Networking, etc.). The virtual port may be a full-sized serial port processing various Serial IOCTL IRPs.

In the above description, the IRP_XXX may refer to the name of the IOCTL IRPs. The others that are not explained are all function names, such as the IO Register Device Interface, etc.

USB protocol supports the “plug-in or out” of a device, but the user should execute the safe removal of hardware application before a device is removed. This program informs the operating system (e.g., Windows) that the user intends to delete a device, and the operating system interrupts the current data transmission and uninstalls the device driver. If a user directly removes the device without executing this safe remove hardware application in advance (usually referred to as a Surprise Removal), it may cause a data loss or a system collapse because the application program still has the Device handle which is no longer allowed by the Pap Manager. An embodiment of the wireless data communication device solves this problem, by informing the application program to release the Device handle at a proper time.

Windows 2000 and Windows 98 both provide a method that informs the user model and a kernel model about a PnP event so that the application program may monitor and control the change in configuration of the hardware and the power supply in the system by processing the message WM_DEVICECHANGE. This method tests the device interface thus permitting a certain driver to enable or disable. The implementation may be divided into two parts, one involving the device driver, and the other, the application program.

For the device driver, the physical device object will receive the message IRP MN-START DEVICE. The Globally Unique Identifier (GUID) will be registered by calling the function for the IO Register Device Interface and the interface is then enabled by calling the function of the IO Set Device Interface State.

For the application program, the present thread, including a window and a message cycle, is established or used, from which the function Register Device Notification is called, and then the PnP manager sends a WM_DEVICECHANGE message to the window when the drive interface GUID is enabled or disenabled. The application program should note that when wParam (an event code) equals DBT_DEVICEQUERYREMOVE, the device type is a WM_DEVICECHANGE message for DBT_DEVTYP_HANDLE, meaning that the interface is going to be disenabled. Therefore, its device handle for this device should close. Then, the TRUE state should be returned unconditionally in the process program of the message.

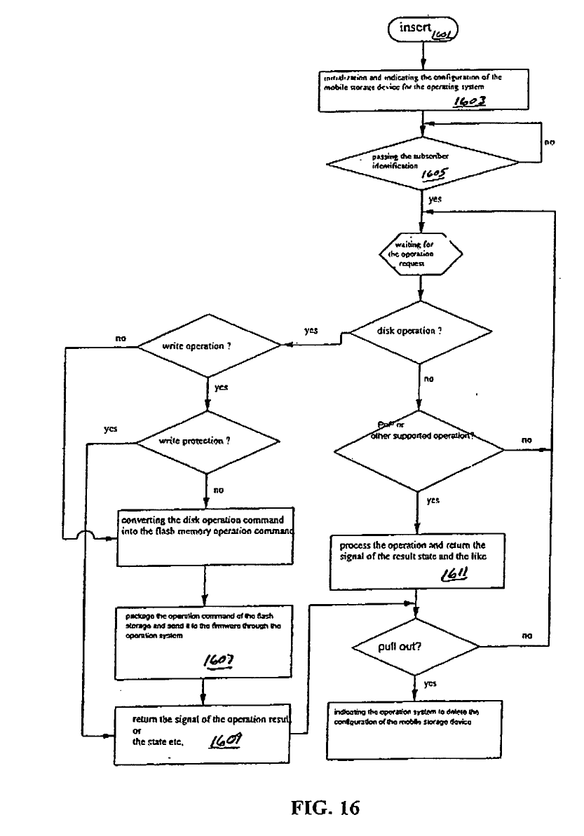

The flow diagram for the driver for installing a mobile storage device is shown in FIG. 16. First the device 100 is inserted 1601. The driver controls the mobile communication device for initialization 1603 and indicates the configuration of the mobile storage device to the operating system, waits for the operational request after passing the subscriber identification 1605, processes the operation request of the write storage module 11 (which may be a flash memory), packages the storage operation commands 1607 and sends it to the firmware through the operating system 1609 and processes 1611 the PnP or other supported operation simultaneously. The operation request waits before the device of the present invention is pulled out, and the operating system will delete the configuration of the mobile storage device after it is pulled out Step 325. The driver for the communication function and the driver for the storage function may be separate, but may be combined in one unit.

The wireless data communication device 100 may use a USB interface to connect with the host and may be a plug and play unit associated with the universal serial bus using the mobile storage technique and the mobile communication technique. The device may use the communication service provided by a mobile telephone corporation 176, as shown in FIG. 17, providing data transmission between the wireless mobile telephone 172 and computer 174, providing reliable performance for mobile storage and wireless communication. The wireless data communication device 100 will access, receive and transmit wireless data information, including speech, data, short messages, and control information. The wireless communication device 100 may make the computer 171 a public wireless network terminal for Internet access.

In an application of use, wireless data communication devices 100 may be installed in more than one port of a multi-port connector attached to a data processing system 171, thus allowing the data processing system 171 to have multiple wireless data communication devices 100, with concurrent access to the devices. Concurrent access permits the application program to use asynchronous access mode for reading/writing to the same device, which may improve the availability to the wireless data communication devices 100, enhancing the throughput of data through the system. Using this technique, the data processing system 171 may receive/transmit short messages in batches without waiting. This technique is suitable for group users. The realization of the concurrent access is that first, the Exclusive mode is designated for the wireless data communication device 100 when the device object is established, and second, when the read/write request (IRP_MJ_READ and IRP_MJ_WRITE) from the upper software (application program) is received, they are queued to that particular wireless data communication device 100 until the message is finished.

An example of the wireless data communication device 100 provides power (4.5V-5.5V) directly through the USB bus, meeting the USB 1.1/2.0 standard, and may be applied to the GSM, GPRS, CDMA, WCDMA, CDMA2000, CDPD, and other wireless communication networks. Another example integrates an electronic identification as each wireless data communication device 100 may have a unique serial number.

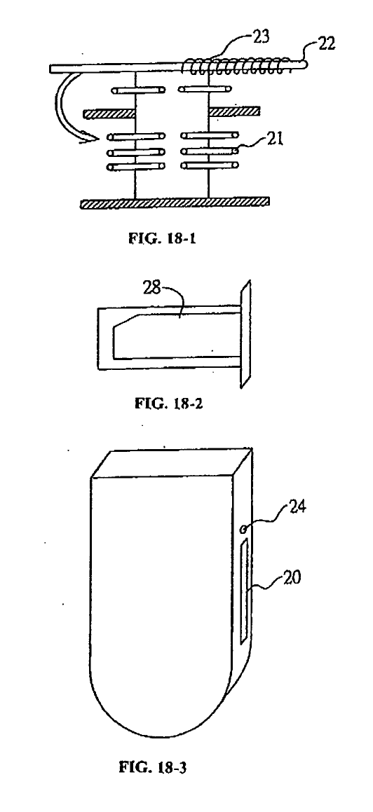

The insertion structural diagram of SIM card is shown in FIG. 18-1. In FIG. 18-3, a narrow slot 20 is located on the wireless data communication device 100 for inserting the SIM card 4 shown in FIG. 18-2. Referring to FIG. 18-1, an electrical contact 21, a lever 22, and a spring 23 are used in the slot for inserting and electrically connecting the SIM card 4. A manipulative point or button 24 is placed next to the narrow slot 20 as shown in FIG. 18-3. Pressing the manipulative button 24 will release the SIM card.

Applications of the wireless data communication device 100 may be applied to the financial field in such areas as securities, insurance, and futures. The wireless data communication device 100 may find applications in civil aviation, railroad, public security, environmental protection, petrochemical industry, maritime industry, and other industries, such as, the remote sale of tickets, remote control, etc.

A typical network diagram 176 is shown in FIG. 17. The service center for the short message service platform connects to an intranet 177 through a network cable, and may exchange short messages with an employee 172 or a client mobile device 175, and other computers having a wireless data communication device 100. Computers having the wireless data communication device 100 may also connect directly to the Internet.

An application for the wireless data communication device 100 allows for a computer to connect directly to the Internet in a wireless mode. Thus, many types of businesses using the Internet will not be restricted by location, but operate in a wireless mode such that the computer becomes a super wireless mobile terminal. Using special software, the encryption storage function may be achieved by using the subscriber identification code to encrypt data transfers, communication, and the like, ensuring the security of the critical business functions.

For example, a short message service platform developed in the software of the wireless data communication device 100 may provide a client service system for a bank, a securities business, or other enterprise. Using a mobile telephone communication mode allows one to communicate with the bank or other enterprise using a short message communication format. The short message formats may include transactional exchanges and the necessary parameters for processing the transactions. Moreover, the service software for out these transactions may be carried in the storage unit of the wireless data communication device. This alleviates the need for a software download or installation into the operating system from the enterprise. The software for performing these operations may be used as a PnP device, stored conveniently and inserted when needed.

It is therefore intended that the foregoing detailed description be regarded as illustrative rather than limiting, and that it be understood that it is the following claims, including all equivalents, that are intended to define the spirit and scope of this invention.

1-20. (canceled)

21. A wireless data communication device for a data processing system, that allows the data processing system to wirelessly communicate with a network, comprising:
an interface module for operatively connecting the wireless data communication device to the data processing system formatted with at least one of a serial, parallel and wireless communication interface;
a wireless transceiver for communicating with the network;
a controller module operatively connected with the interface module and the wireless transceiver module controlling communications between the wireless data communication device, the data processing system, and the network;
a storage media module operatively connected with the controller module for storing media drivers for interfacing with the data processing system;
an identification code module operatively connected with the controller module and storing identification codes for providing at least one of encryption, identification of the data, and an identification of the wireless data communication device;
a wireless network Subscriber Identification Module (SM) connected to the transceiver module; and
a narrow slot for an electronic card insertion.

22. The device of claim 21, further comprising a storage media module using a flash memory.

23. The device of claim 21, further comprising an interface module that uses at least one of an Universal Serial Bus (USB), IEEE 1394, Personal Computer Memory Card (PCMCIA), CP and Bluetooth interface.

24. The device of claim 21, further comprising a power supply for the wireless data communication device where the power supply is connected via the serial or parallel interface.

25. The device of claim 21, further comprising an indicating element for indicating the operating state of the wireless data communication device.

26. The device of claim 25, characterized in that the indicating element is a LED, LCD, vibrator or sounder.

27. The device of claim 21, further comprising a write protection switch for preventing the data from being written into the storage media module.

28. The device of claim 21, wherein the narrow slot further comprises:
an electrical contact inside the narrow slot for operatively connecting the SIM card when inserted;
a lever mounted in the slot;
a spring attached to the lever for pushing the SIM; and
a manipulative point set beside the narrow slot, where pressing the manipulative point releases the inserted SIM card.

29. A method for a data processing system to wirelessly communicate data with a network, comprising the following steps of:
A. providing a wireless data communication device having a wireless transceiver module for receiving and transmitting data information, a controller module for controlling the wireless data communication device, and an interface module in communication with the data processing system, wherein the wireless data communication device is operatively connected to the data processing system,
B. establishing an information exchange channel through the interface module between the wireless data communication device and the data processing system wherein the interface module is at least one of a series, parallel and wireless communication interface;
C. transferring data over the information exchange channel; and
D. communicating data over a public wireless network with the transceiver module.

30. The method of claim 29, farther comprising establishing the information exchange channel by inserting the wireless data communication device into a port on the data storage system.

31. The method of claim 30, further comprising locating a driver for the wireless communication device in the data processing system at time of power-up wherein the controller module executes the firmware for the driver for the data communication device.

32. The method of claim 30, further comprising establishing communication includes an indication of a configuration of a mobile storage device in the wireless communication device to an operating system of the data processing system.

33. The method of claim 32, further comprising generating an interrupt signal from the interface module to the control module so that the control module establishes contact with an operating system in the data processing system.

34. The method of claim 29, wherein the interface module is at least one of a Universal Serial Bus (USB), IEEE 1394, Personal Computer Memory Card (PCMCIA), CP or Bluetooth interface.

35. The method of claim 30, further comprising testing for the interface module so that an operating system monitors and controls the change in a configuration in hardware.

36. The method of claim 35, where the wireless communication device is a plug and play module.

37. The method of claim 35, where the operating system deletes the configuration of the interface module when the wireless data communication device is removed from the data processing system.

38. The method of claim 29, where the public wireless network is at least one of a Global System for Communication (GSM), General Packet For Radio Service (GPRS), Code-Division Multiple Access (CDMA), wide-band CDMA (WCDMA), CDMA2000 and Cellular Digit Packet Data (CDPD) network.

39. The method of claim 29, where the wireless data communication device provides access to the Internet to a mobile device that communicates with the data processing system.

40. The method of claim 29, wherein a plurality of wireless data communication devices are operatively connected to the data processing system.
